(19) United States
(12) Patent Application Publication
(10) Pub. No.: US 2022/0067847 A1
(43) Pub. Date: Mar. 3, 2022

(54) SYSTEM AND METHOD FOR NETWORKING A PLURALITY OF AGRICULTURAL FARMS

(71) Applicant: 365FarmNet Group KGaA mbH & Co. KG, Harsewinkel (DE)

(72) Inventor: Marten Grundmann, Berlin (DE)

(73) Assignee: 365FarmNet Group KGaA mbH & Co. KG, Harsewinkel (DE)

(21) Appl. No.: 17/465,241

(22) Filed: Sep. 2, 2021

(30) Foreign Application Priority Data
Sep. 3, 2020 (DE) 102020123002.8

(51) Int. Cl. G06Q 50/02; G06Q 10/06; G06Q 30/02; G06Q 10/08; G06F 16/953; H04L 29/08

(52) U.S. Cl. CPC G06Q 50/02; G06Q 10/06315; G06Q 30/0201; H04L 67/12; G06F 16/953; H04L 67/10; G06Q 10/0875

(57) ABSTRACT

A system and method for networking a plurality of agricultural farms is disclosed. The system and method use a server platform, whereby the agricultural farms use at least one computer-supported administration system to plan and perform agricultural processes, and to administer required resources. The server platform has an input interface for input and/or receipt of selectable basic data of each of the farms connected to the server platform. The server platform has a data interface providing information on resources to perform the agricultural processes that are provided by a resource provider. The server platform evaluates the basic data transmitted by the administration system in order to aggregate a resource requirement of a plurality of agricultural farms. The server platform accounts for the aggregated resource requirements and the information from the resource provider, automatically selects a resource provider and transmits the offer corresponding to the aggregated resource requirement.

### CROSS REFERENCE TO RELATED APPLICATIONS

This application claims priority under 35 U.S.C. § 119 to German Patent Application No. DE 102020123002.8 filed Sep. 3, 2020, the entire disclosure of which is hereby incorporated by reference herein.

### TECHNICAL FIELD

The present invention relates to a system and method for networking a plurality of agricultural farms using a server platform.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Agricultural farms may require a wide variety of regularly recurring resources of many types in order to cultivate crops and/or raise livestock. To accomplish this, depending on the type of resources to be used at different points in time, there may be requirements that arise which the farms may have to cover, sometimes promptly, in order to plan agricultural processes and ensure the provision of the necessary resources for performing the agricultural processes.

### DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates a schematic representation of an overview of agricultural farms and resource providers of agricultural resources that communicate with each other via a server platform; and

FIG. 2 illustrates a schematic representation of the proposed method for networking a plurality of agricultural farms by means of the server platform.

### DETAILED DESCRIPTION

As discussed in the background, requirements may arise which the farms may have to cover in order to plan agricultural processes and ensure the provision of the necessary resources for performing the agricultural processes. Given the ever-increasing costs in generating agricultural and livestock products, cost-effective procurement of resources may be of particular importance.

Against this backdrop, a method and a system (including a server) for networking a plurality of agricultural farms is disclosed that improves or optimizes the procurement of resources.

Thus, in one or some embodiments, by bundling the procurement of resources of a plurality of agricultural farms, a concentration or synergy may be achieved using a server platform that results in greater purchase volumes. With the greater purchase volumes, improved purchasing conditions may generally be achieved in the procurement of resources.

In one or some embodiments, a method is disclosed for networking a plurality of agricultural farms using a server platform, wherein the agricultural farms use at least one computer-supported administration system to perform any one, any combination, or all of: plan agricultural processes, perform the agricultural processes, and administer the required resources. The server platform has an input interface that serves for the input and/or the receipt of selectable basic data of one, some or each of the farms connected to the server platform. The selectability of the basic data makes it possible for the farmer of the particular farm to influence or affect the data to be transmitted. For example, the farmer may select from a plurality of available data and/or data sources, for transmission to the server platform. The server platform has a data interface that is configured to provide information on resources to perform the agricultural processes that are provided by at least one resource provider. The server platform performs an evaluation (such as an automatic evaluation) of the basic data transmitted by the at least one administration system in order to aggregate (such as automatically aggregate) at least one resource requirement of a plurality of agricultural farms. The server platform, taking into account the at least one aggregated resource requirement and the information from the at least one resource provider, may automatically select a resource provider and transmit the offer corresponding to the at least one resource requirement to the selected resource provider. In turn, the offer may be used by the selected resource provider in order to schedule the delivery of the at least one resource requirement. For example, the server platform may schedule the physical delivery of the resource requirement (e.g., send electronic notifications to a computer, smartphone, email address, or the like associated with the at least one resource provider requesting to schedule the delivery) and/or perform the actual delivery of the resource requirement. In turn, the at least one resource requirement may be physically delivered from a warehouse or the like that is controlled by the selected resource provider to one or more of the plurality of farms. After the delivery, the plurality of farms may use the delivered resource requirement. In this way, the server platform may communicate (such as perform real-time communication) in a unique manner with one or more electronic devices associated with any one, any combination, or all of the administration system(s) associated with agricultural farm(s), electronic devices associated with the resource provider(s), or other electronic devices disclosed herein in order to better manage (such as transport) of the at least one resource requirement.

In one or some embodiments, an independent administration system may be provided for each agricultural farm that communicates with the server platform. A centralized administration system is also contemplated that may be used by one, some, or a plurality of the agricultural farms.

In one or some embodiments, the resource requirements of agricultural farms may be checked with respect to their equivalence or similarity and aggregated. This allows equivalent or similar resources to be determined, which may enable bundling. A similarity of resources may mean that there are merely different manufacturers for a resource that is otherwise the same. Using the entry interface, this information may be transmitted as basic data by the administration system to the server platform. This may also allow the variety of offers and the resulting availability of a specific resource to be derived.

In one or some embodiments, the resource requirements of the agricultural farms may be checked and aggregated (such as automatically aggregated) with respect to a matching requirements schedule. In particular, a matching requirements schedule may result with respect to scheduling of any one, any combination, or all of: sowing; spreading manure; the use of herbicides; etc. A matching requirements schedule may also result from the cultivation of the same crop rotations by different agricultural farms. Using the entry interface, this information may be transmitted as basic data by the administration system to the server platform.

In one or some embodiments, agricultural farms may be checked and aggregated with respect to the existence of a physical proximity to each other by using location data. This may allow the logistical effort for delivering resources to be reduced, improved and optimized. Location data may include for example GPS data or an IP address of the administration system in addition to conventional address data of the agricultural farms, which may be used in order to perform automatic aggregation.

In the process, any one, any combination, or all of raw materials, auxiliaries, operating materials, or replacement parts for agricultural work machines and/or work assemblies may be conveyed by the server platform as resources of the agricultural farms for which the resource requirement exists. In so doing, seed for example forms a raw material as the starting point for the subsequent agricultural product. Auxiliaries may, for example, be any one, any combination, or all of manure, pesticides, silage additive, etc. that promote or help the process of growth or the processing of the harvested material. Additional auxiliaries may be feed, straw, etc. that are needed on agricultural farms with livestock. Operating materials may include, inter alia, things that may allow the operation of agricultural work machines and work assemblies. Operating materials may accordingly be lubricants, fuels, and the like. Operating materials may also be understood to be replacement parts that are used to a significant extent and that may regularly wear out from the operation of the work machine and/or work assembly.

In particular, the particular resource requirement of an individual agricultural farm may be determined based on quantifiable data saved in the at least one administration system, wherein these may be any one, any combination, or all of: master data; consumption data; inventory data; planning data; yield data; or procurement data. In particular, a consumption history documented using the administration system of the particular farm may form a basis in requirements planning that is analyzed by an evaluation unit of server platform. The individual consumption history of a particular agricultural farm may, inter alia, provide information on any one, any combination, or all of the time, amount, location, type, or manufacturer of the utilized resource. The consumption history may accordingly at least reflect master data and consumption data. Furthermore, inventory data may be taken into account in determining the resource requirement. In addition, information on storage capacity may however be considered in determining the resource requirement. In determining the resource requirement, planning data and/or yield data may be particularly important in being able to determine a changing requirement, for example due to a change in the crop type or crop rotation, or a change in the agriculturally used areas to be farmed. Moreover, procurement data such as the individual ordering time of a resource and a specific resource provider may influence the determination of the resource requirement. Thus, the resource requirement of the plurality of agricultural farms networked with each other may be aggregated depending on specific economic data provided via the input interface from a respective farm.

In one or some embodiments, information from the at least one resource provider may be determined by a server platform query tool, wherein the query tool may ascertain and evaluate available product data on a network, such as on the Internet, from the at least one resource provider, and the ascertained product data may be compared with available product data from other resource providers. To accomplish this, product data on the offered resources published, for example, on a homepage of a resource provider may be requested. Product data may include inter alia any one, any combination, or all of: the availability of a resource; the delivery time of the resource; the price of the resource; or the type or manufacturer of the resource.

Alternatively, or in addition, a query depending on a certain resource requirement for product data to be provided by the at least one resource provider may be automatically generated and sent by the server platform to the resource provider. In so doing, based on the evaluation of the basic data such as the local or regional location of the agricultural farms, the type of resource requirement, etc., potential resource providers may be determined to whom an automatically generated query is sent. The resource providers may submit offers prepared on the basis of the aggregated resource requirement which are transmitted using the data interface to the server platform.

Alternatively, or in addition, the at least one resource provider may provide, via the data interface, relevant data on its resources for preparing the offer. This may allow the at least one resource provider to independently provide the product data necessary for an evaluation of the selection of a resource provider. This may, for example, be in the form of price lists that are transmitted by the at least one resource provider via the data interface to the server platform.

The product data of the at least one resource provider may be, inter alia, any one, any combination, or all of delivery conditions, available quantities, delivery periods, or the type of available resources. The merging of basic data from the agricultural farms on the one hand and the product data from the at least one resource provider on the other hand may allow the server platform to provide the farmers of the agricultural farms with information, for example via the evaluation unit, on any delivery bottlenecks for a specific resource. Conversely, the at least one resource provider may be notified early on by the server platform of an increasing requirement for a specific resource.

In one or some embodiments, a response from the at least one resource provider to the query, and/or relevant product data provided via the data interface, may be automatically evaluated by the server platform and compared with available information from other resource providers. Accordingly, an improved or optimized offer may be prepared based on the evaluation. This may be based on the fact that several resource providers may each submit an offer to the aggregated resource query, and the server platform may automatically select the best offer.

In particular, the offer may be transmitted to the particular administration system of the networked farms. This makes it possible for the farmers of the agricultural farms to verify and approve or reject an improved or optimized offer determined by the server platform.

In one or some embodiments, the at least one administration system of an agricultural farm may be provided and run centrally on the server platform. This simplifies the data transfer of the particular connected farm to the server platform. The relevant basic data of each agricultural farm networked by the server platform may be available centrally and regularly updated. Accordingly, a change in the inventory of raw materials or auxiliaries and operating materials may, for example, be logged by an agricultural work machine and/or an agricultural work assembly in that, for example, the dispersal of seed, manure or pesticides is detected by sensors and saved geo-referenced in the administration system. The consumption of auxiliaries and operating materials may be ascertained and logged from the length of use, traveled distances and/or measured consumption by the agricultural work machine.

In one or some embodiments, a platform-independent language or a platform-independent communication protocol may be used to exchange data between the administration systems of a particular agricultural farm and the server platform. This is advantageous if administration systems of different suppliers or different farmers are used on the agricultural farms that, when the administration systems are centralized, generally do not communicate with each other. For example, selected basic data may be transferred using an extensible markup language (XML) between the particular administration system and the server platform.

In one or some embodiments, a server platform is disclosed which may be configured to perform any one, any combination, or all of the methods disclosed herein.

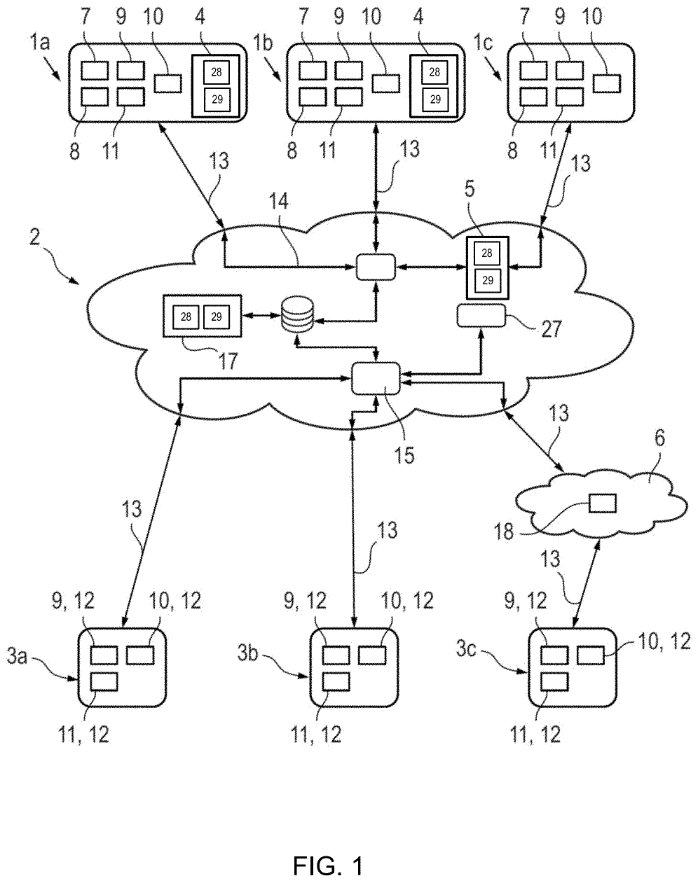

Referring to the figures, FIG. 1 shows a schematic representation of an overview of a plurality of agricultural farms 1a, 1b, 1c and various resource providers 3a, 3b, 3c of resources for the agricultural farms 1a, 1b, 1c that indirectly communicate with each other via a server platform 2. The agricultural farms 1a, 1b, 1c include any one, any combination, or all of agricultural work machines 7, agricultural work assemblies 8, raw materials 9, auxiliaries 10 and operating materials 11 for performing agricultural processes such as cultivating and harvesting crops and/or farming livestock, wherein the raw materials 9, auxiliaries 10 and operating materials 11 will hereinafter be generally termed resources 12. A computer-supported administration system 4, 5 is included and configured to plan and perform agricultural processes and to administer the resources 12 of an agricultural farm 1a, 1b, 1c. For the farms 1a, 1b, the computer-supported administration system 4 is for example located on their farmland, or respectively in a farmstead.

The computer-supported administration system 4, 5 includes a computing unit, a memory unit, as well as an input/output unit. This is depicted as processor 28 and memory 29. The computer-supported administration system 4, 5 may comprise any type of computing functionality, such as at least one processor 28 (which may comprise a microprocessor, controller, PLA, or the like) and at least one memory 29 in order to perform the disclosed image recognition, the processing to determine the indicator of the structural percentage, and/or any other processing disclosed herein. The memory may comprise any type of storage device (e.g., any type of memory). Though the processor 28 and memory 29 are depicted as separate elements, they may be part of a single machine, which includes a microprocessor (or other type of controller) and a memory.

The processor 28 and memory 29 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

At least one database is saved in the memory unit, such as in memory 29. The computing unit, which may include processor 28, is configured to execute program code that may be saved on the memory unit, such as in memory 29. The inventories of the resources 12 may be administered by the administration system 4. The administration of resources 12 includes recording information on any one, any combination, or all of the delivery, the type, the resource provider 3a, 3b, 3c, or the manufacturer of a resource 12. The recording may be by manual data entry in the administration system 4, 5, or automated by measuring the resources 12. Moreover, the use, removal or consumption of resources 12 while performing agricultural processes may be recorded and documented. Recording the use, the removal, and the consumption of resources 12 may be performed by measuring with suitable sensor devices, for example by the agricultural work machines 7 and/or the agricultural work assemblies 8. Moreover, the recording may be geo-referenced by the agricultural work machines 7 and/or the agricultural work assemblies 8. In this manner, the resource consumption may be assigned to individual locations of use of agricultural work machines 7 and/or agricultural work assemblies 8 such as a field or premises of an agricultural farm 1a, 1b, 1c.

In this case, seed, for example, forms a raw material 9 as a starting point for the subsequent agricultural product that is dispersed by a seed drill as an agricultural work assembly 8. Auxiliaries 10 may, for example, be manure, pesticides, silage additive, etc. that promote or help the process of growing the harvested material or its processing. Additional auxiliaries 10 may be feed, straw, etc. that are needed on agricultural farms 1a, 1b, 1c with livestock. Operating materials 11 include inter alia means that primarily allow the operation of agricultural work machines 7 and agricultural work assemblies 8. Operating materials 11 may accordingly be lubricants, fuels etc. that are consumed to a great extent. Operating materials 11 may also be replacement parts that must be procured regularly and in large amounts to ensure the functioning of the agricultural work machines 7 and agricultural work assemblies 8.

Moreover, the administration system 4, 5 is configured to document the consumption data of resources 12 as well as yield data from a previous year that are to be used to plan the following year, or that serve to create planning data. For example, yield data may be regularly measured by the agricultural work machines 7 and agricultural work assemblies 8 during or after a harvesting process and transmitted to the administration system, in particular automatically. In this manner, the specific use of any one, any combination, or all of raw materials 9, auxiliaries 10, or operating materials 11 may be compared with the achieved yield by the administration system 4, 5 and evaluated to generate planning data.

An alternative is shown only as an example of the agricultural farm 1c in which the computer-supported administration system 5, whose structure and functioning is identical with the above-described administration system 4, may be a component of the server platform 2. For this purpose, the computer-supported administration system 5 may be designed to be cloud-based.

The bidirectional communication of the agricultural farms 1a, 1b, 1c with the server platform 2 may occur via suitable wireless or wired communication means 13. The server platform 2 has an input interface 14 that serves for the input and/or the receipt of selectable basic data of each of the farms 1a, 1b, 1c connected to the server platform 2.

The resource providers 3a, 3b, 3c at least partially offer the resources 12 needed for the agricultural farms 1a, 1b, 1c. Like the agricultural farms 1a, 1b, 1c, the resource providers 3a, 3b, 3c are connected by suitable communication means 13 to the server platform 2. In the example of the resource provider 3c, communication with the server platform 2 is not performed directly via dedicated communication means 13, but rather via a public network 6, such as the Internet. In the case of the Internet, the network 6 may also function as a data source. The server platform 2 has a data interface 15 that serves to provide information on resources 12 that are needed to perform the agricultural processes and are provided by at least one resource provider 3a, 3b, 3c.

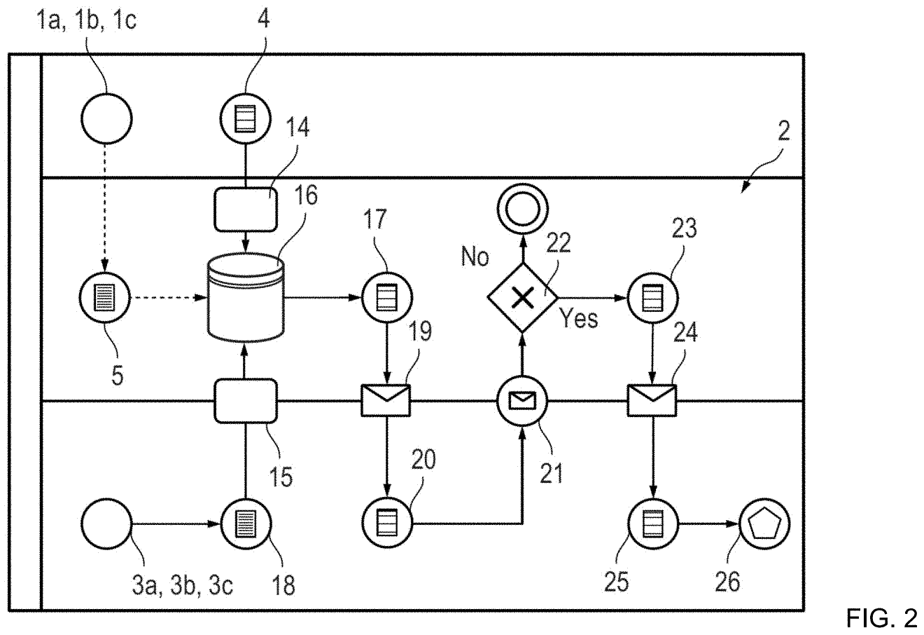

FIG. 2 schematically shows the disclosed method for networking a plurality of agricultural farms 1a, 1b, 1c using the server platform 2. The farmers of the agricultural farms 1a, 1b, 1c maintain data in the respective administration system 4, 5 in order to log any one, any combination, or all of the utilization of the resources 12, the use of agricultural work machines 7, agricultural work assemblies 8, or the associated achieved results of work or yields, as already explained above.

In one or some embodiments, selectable basic data provided by the computer-supported administration system 4, 5 and the farmers of the respective agricultural farm 1a, 1b, 1c are transmitted via the input interface 14 to the server platform 2. The respective resource requirement of an individual agricultural farm 1a, 1b, 1c is determined based on the quantifiable data saved in the administration system 4, 5, wherein these are master data, consumption data, inventory data, planning data, yield data and procurement data of the resources 12. These data may be identical to the basic data received from the server platform 2 via the input interface 14 or entered basic data.

The basic data may be compiled in a database 16 of the server platform 2 and supplied to an evaluation unit 17. The evaluation unit 17, which may comprise any contemplated computing functionality and is depicted as including at least one processor 28 and at least one memory 29, is configured to evaluate the basic data of the various farms 1a, 1b, 1c with respect to existing matches in order to aggregate the resource requirements of several farms 1a, 1b, 1c. In so doing, the requirements of resources 12 of the agricultural farms 1a, 1b, 1c may, for example, be checked with respect to their equivalence or similarity and aggregated. Accordingly for example, the evaluation unit 17 may determine a matching of the requirement of identical raw materials 9 of the various farms 1a, 1b, 1c. A similarity may exist when lubricants are used on the respective farms 1a, 1b, 1c as an operating material 11 that only differ from each other in terms of the manufacturer or the resource provider 3a, 3b, 3c. In this regard, the evaluation unit 17 may automatically analyze operations across different farms and make conclusions accordingly (such as similarities or differences in operations), and in turn automatically aggregate the resource requirements.

Another aspect of the evaluation is that the resource requirements of the agricultural farms 1a, 1b, 1c are checked with respect to their matching requirement schedule. In so doing, matching requirement schedules for sowing, spreading manure, pesticides, etc. may result, such as based on the planning data created by the administration system 4, 5. A matching requirement schedule may also result in the simplest case from the cultivation of the same crop rotations by different agricultural farms 1a, 1b, 1c.

It is moreover advantageous if agricultural farms 1a, 1b, 1c are checked with respect to the existence of a physical proximity to each other by using location data. In this manner, at least regionally adjacent farms 1a, 1b, 1c may be determined and aggregated. This allows the logistical effort for delivering resources 12 to be reduced and optimized. In this regard, separate from (or in addition to) operations that may be affected, transportation or delivery of resources may likewise be affected (e.g., the delivery of resources may be aggregated so that physically proximate farms may receive deliveries in combination). In addition to conventional address data of the agricultural farms 1a, 1b, 1c, location data may for example be GPS data or an IP address of the administration system 4, provided that the administration system 4 is on the farmstead of the farm 1a, 1b. The location data may also be evaluated in light of a potential spatial proximity of one or more resource providers 3a, 3b, 3c. By an automatic aggregation of several individual resource orders, delivery and transport costs may be reduced. In particular, automatically aggregating several individual resource orders into a single order may affect the delivery and transport. For example, the movement, from a physical standpoint, of the resource from the warehouse or the like controlled by the resource provider, to one or more of the plurality of farms. In this way, the aggregation may affect both the physical transport of the resource as well as the ultimate use of the resource on the one or more farms.

Additional basic data may include information on the agricultural farms 1a, 1b, 1c or their farmers and may be provided by the administration system 4, 5. The particular purchasing history may include any one both of the individual time at which a particular farm 1a, 1b, 1c orders or purchases a resource 12 may be counted or the readiness of the farmer of a farm 1a, 1b, 1c to pay for specific resources 12 by a brand manufacturer at a higher price.

The evaluation unit 17 of the server platform 2 is configured to evaluate the available basic data from the various farms 1a, 1b, 1c and thereby configured to automatically aggregate the purchase volumes for one or more resources 12.

The resource providers 3a, 3b, 3c have access via the data interface 15 to the at least one database 16 of the server platform 2 in order to provide product data 18 for the various resources 12. This allows the resource providers 3a, 3b, 3c to provide via the data interface 15 inter alia the product data 18 which includes price lists, availability information, specific product information, etc. Alternatively, the resource providers 3a, 3b, 3c may be automatically informed by the server platform 2 that several agricultural farms 1a, 1b, 1c that want to order one or more specific resources 12 have been aggregated. In response to this transmission of information, the resource providers 3a, 3b, 3c may transmit an individual offer via the data interface 15. Alternatively, determining product data 18 on offered resources 12 comprises the server platform 2 determining and evaluating data published on the network 6, for example from the resource provider 3c. To accomplish this, product data 18 from the at least one resource provider 3a, 3b, 3c may be determined by a query tool 27 of a server platform 2, wherein the query tool 27 ascertains and evaluates available product data 18 on a network 6, such as on the Internet, from the at least one resource provider 3a, 3b, 3c, and the ascertained product data 18 are compared with available product data 18 from other resource providers 3a, 3b, 3c.

To accomplish this, the resource query aggregated by the service platform 2 may be transmitted via a portal 19 to the resource providers 3a, 3b, 3c that were ascertained by the service platform 2 using the available product data 18. In method step 20, the resource providers 3a, 3b, 3c are thereby able to check the aggregated resource query and send an offer based on the product data 18 saved in the database 16 of the server platform 2, or modify an existing offer, for example based on a published or transmitted price list. In method step 21, the offer from the respective resource provider 3a, 3b, 3c is transmitted to the service platform 2 via the portal 19 and accepted or rejected by an evaluation unit 17 in a decision step 22 in which the aggregated resource query is compared with the offers.

In the event of acceptance, the order may be automatically initiated by the service platform 2 in method step 23 and transmitted to the selected resource provider 3a, 3b, 3c. To accomplish this, a corresponding order is sent using the portal 19 to the selected resource provider 3a, 3b, 3c in method step 24. This causes the order to be initiated in method step 25. The delivery of the ordered resources 12 to the agricultural farms 1a, 1b, 1c that were combined by the server platform 2 is designated as method step 26.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| 1a, 1b, 1c | Agricultural farm |
|---|---|
| 2 | Server platform |
| 3a, 3b, 3c | Resource provider |
| 4 | Administration system |
| 5 | Administration system |
| 6 | Network |
| 7 | Agricultural work machine |
| 8 | Agricultural work assembly |
| 9 | Raw material |
| 10 | Auxiliaries |
| 11 | Operating materials |
| 12 | Resource |
| 13 | Communication media |
| 14 | Input interface |
| 15 | Date interface |
| 16 | Database |
| 17 | Evaluation unit |
| 18 | Product data |
| 19 | Portal |
| 20 | Method step |
| 21 | Method step |
| 22 | Decision step |
| 23 | Method step |
| 24 | Method step |
| 25 | Method step |
| 26 | Method step |
| 27 | Query tool |
| 28 | Processor |
| 29 | Memory |

1. A method for networking a plurality of agricultural farms using a server platform, the server platform communicating with at least one computer-supported administration system, used by the plurality of agricultural farms, in order to plan agricultural processes, perform the agricultural processes, and administer required resources, the method comprising:
one or both of inputting or receiving, via an input interface of the server platform, selectable data of at least some of the plurality of agricultural farms in communication with the server platform;
providing, via a data interface of the server platform, information on resources to perform the agricultural processes that are provided by at least one resource provider;
automatically evaluating, by the server platform, the data transmitted by the at least one computer-supported administration system;
automatically aggregating, by the server platform and based on the evaluation, at least one resource requirement of the plurality of agricultural farms;
automatically selecting, by the server platform and based on the at least one resource requirement that is aggregated and the information on resources from the at least one resource provider, a resource provider; and
automatically transmitting to the resource provider an offer corresponding to the at least one resource requirement that is aggregated,
wherein the offer is used in order to transport the at least one resource requirement to one or more of the plurality of agricultural farms or the at least one resource requirement is used in performing the agricultural processes for the one or more plurality of agricultural farms.

2. The method of claim 1, wherein the at least one resource requirement of the plurality of agricultural farms are checked with respect to their equivalence or similarity in order to be aggregated.

3. The method of claim 2, wherein the at least one resource requirement of the plurality of agricultural farms are further checked with respect to a matching requirements schedule in order to be aggregated.

4. The method of claim 1, wherein the plurality of agricultural farms are checked with respect to existence of a physical proximity to each other by using location data in order to perform the automatic aggregating.

5. The method of claim 1, wherein one or more of raw materials, auxiliaries, operating materials, or replacement parts for one or both of agricultural work machines or agricultural work assemblies are conveyed by the server platform as resources of the plurality of agricultural farms for which the at least one resource requirement exists.

6. The method of claim 1, wherein a particular resource requirement of an individual agricultural farm is determined based on quantifiable data saved in the at least one computer-supported administration system; and
wherein the quantifiable data comprises one or more of master data, consumption data, inventory data, planning data, yield data or procurement data.

7. The method of claim 1, wherein the at least one resource requirement of the plurality of agricultural farms networked with each other is aggregated depending on specific economic data provided via the input interface from a respective farm.

8. The method of claim 1, wherein information from the at least one resource provider is determined by a query tool of the server platform;
wherein the query tool ascertains and evaluates available product data on a network from the at least one resource provider; and
wherein the available product data from the at least one resource provider are compared with available product data from other resource providers.

9. The method of claim 1, wherein a query, depending on a resource requirement for product data to be provided by the at least one resource provider, is automatically generated and sent by the server platform to the at least one resource provider.

10. The method of claim 9, wherein product data is received, via the data interface, from the at least one resource provider with respect to its resources for preparing the offer.

11. The method of claim 10, wherein, responsive to sending the query, one or both of a response or the product data is received from the at least one resource provider;
wherein the server platform automatically evaluates by comparing the one or both of the response or the product data with available product data from one or more other resource providers; and
wherein the server platform prepares an offer based on the evaluation.

12. The method of claim 11, wherein the offer is transmitted to a particular administration system of one of the plurality of agricultural farms.

13. The method of claim 12, wherein the particular administration system of an agricultural farm is provided and run centrally on the server platform.

14. The method of claim 13, wherein a platform-independent language or a platform-independent communication protocol is used to exchange data between the particular administration system and the server platform.

15. A server platform comprising:
one or more communication interfaces configured to communicate with at least one computer-supported administration system used by a plurality of agricultural farms;
at least one processor in communication with the one or more communication interfaces and configured to:
input or receive, via the one or more communication interfaces, selectable data of at least some of the plurality of agricultural farms in communication with the server platform;
provide, via the one or more communication interfaces, information on resources to perform the agricultural processes that are provided by at least one resource provider;
automatically evaluate the data transmitted by the at least one computer-supported administration system;
automatically aggregate, based on the evaluation, at least one resource requirement of the plurality of agricultural farms;
automatically select, based on the at least one resource requirement that is aggregated and the information on resources from the at least one resource provider, a resource provider; and
automatically transmit to the resource provider an offer corresponding to the at least one resource requirement that is aggregated,
wherein the offer is used in order to transport the at least one resource requirement to one or more of the plurality of agricultural farms or the at least one resource requirement is used in performing the agricultural processes for the one or more plurality of agricultural farms.

16. The server platform of claim 15, wherein the processor is configured to automatically aggregate the at least one resource requirement by analyzing the at least one resource requirement of the plurality of agricultural farms with respect to their equivalence or similarity.

17. The server platform of claim 16, wherein the processor is configured to automatically aggregate the at least one resource requirement by further checking a matching requirements schedule in order to aggregate the at least one resource requirement.

18. The server platform of claim 17, wherein the processor is configured to automatically aggregate the at least one resource requirement by further checking physical proximity of the plurality of agricultural farms to each other using location data in order to perform the automatic aggregating.

19. The server platform of claim 15, further comprising a query tool;
wherein information from the at least one resource provider is determined by the query tool of the server platform;
wherein the query tool is configured to ascertain and evaluate available product data on a network from the at least one resource provider; and
wherein the server platform is further configured to compare the available product data from the at least one resource provider with available product data from other resource providers.

20. The server platform of claim 15, wherein the processor is further configured to generate and send a query to the at least one resource provider, the query depending on a resource requirement for product data to be provided by the at least one resource provider.
